(19) United States
(12) Patent Application Publication
(10) Pub. No.: US 2020/0207048 A1
(43) Pub. Date: Jul. 2, 2020

(54) Method and Apparatus for Making Bags with Hem Seals

(71) Applicant: CMD Corporation, Appleton, WI (US)

(72) Inventors: Timothy J. Rymer, Neenah, WI (US); Charles H. Sauder, Appleton, WI (US); Thomas C. Jansen, Appleton, WI (US); Curt A. Frievalt, Green Bay, WI (US); Scott A. Beinema, Little Chute, WI (US)

(73) Assignee: CMD Corporation, Appleton, WI (US)

(21) Appl. No.: 16/727,719

(22) Filed: Dec. 26, 2019

Related U.S. Application Data
(60) Provisional application No. 62/787,674, filed on Jan. 2, 2019.
(60) Provisional application No. 62/787,539, filed on Jan. 2, 2019.

(51) Int. Cl. B31B 70/81; B29C 65/00

(52) U.S. Cl. CPC B31B 70/8134; B31B 2155/00; B29C 66/1352

(57) ABSTRACT

A method and apparatus for making bags with hem seals is disclosed. The machine includes an infeed section and a draw tape section. Bags are made from a film and a film path extends through the infeed section and through the draw tape section. The draw tape section includes a hem sealer that includes a stationary sealing plate on one side of the film path such that film path passes across the stationary plate. A sealing head is on the second side of the film path, opposite the first side, such that the film following the film path passes between the sealing head and the stationary plate. A sealing section may be included. The draw tape section may include driven infeed an outfeed nips.

### FIELD OF THE INVENTION

The present disclosure relates generally to the art of making bags. More specifically, it relates to making bags that have a draw string or tape and hem seals.

### BACKGROUND OF THE INVENTION

Plastic bags of the type described herein are typically comprised of a bag body folded to form top and bottom layers which are typically cut and sealed at the side edges. The front edges of the top and bottom layers, located opposite the fold, define the mouth of the bag. A near margin at the bag mouth is typically folded inside the bag to form a hem which is ordinarily sealed to the bag body to form a channel holding draw tapes or strings. Pulling on accessible portions of the draw tapes causes the bag mouth to constrict thus closing the bag at its top.

In making a draw tape bag in the conventional art, plastic film material is generally obtained in rolls. The roll is unwound and fed to a draw tape section. The draw tape section forms hems at edges of the web which ultimately form the top edges of the finished bag, and incorporates draw tape material into the hems, in addition to cutting holes at the edges which form the top edges of the finished bag. The hem is sealed, securing the tapes in the formed hems. In the alternative, the plastic film material may be received in-line, from an ongoing film extrusion process.

In effecting the tape insertion, one or two strips of tape material are unwound from respective parent rolls and fed to the formed hems of the respective top and bottom layers. Accordingly, a draw tape section must handle at least the main web which is used to form the plastic bag, as well as the one or two tape webs being inserted into the hems. Normally two sets of sealing bars or the like are required for forming the heat seals at the respective two hems after the tapes are inserted.

Finally, after the draw tape insertion process is completed, the web is transferred from the draw tape section to a bag-forming section where transverse side seals, and corresponding cuts, are made across the width of the plastic web, forming side seals and cutting the continuous web into individual bags, using conventional heat sealing and cutting equipment and methods. The steps that form the side seals and cut the sides of succeeding bags from each other also seal the draw tapes, in the hems, to the bag material, itself, along the side edges of the bags, as well as cutting the tapes to a length corresponding to the full widths of the bags being fabricated.

Improved draw tape sections, such as those described in U.S. Pat. Nos. 5,857,953 and 5,797,828 (both hereby incorporated by reference) form hems around the draw tapes, rather than inserting the draw tapes into already-formed hems. This improved the speed of draw tape sections, allowed for continuous motion draw tape bag sections, and increased the quality and consistency of draw tape bags produced. One system using the improvements described in U.S. Pat. Nos. 5,857,953 and 5,797,828 is the CMD™ 1270GDS™. This draw tape system (or machine) includes a rotary drum, such as that described in U.S. Pat. No. 6,117,058 (hereby incorporated by reference), or could be used with the sections described in U.S. Pat. Nos. 7,445,590, 8,029,428 and 8,998,787 (each of which is hereby incorporated by reference).

While such draw tape bag machines were improvements over the prior art, they form the hem seal while the film (and draw tape) is guided on an endless belt (see, for example, belt 146 in U.S. Pat. Nos. 5,857,953 and 5,797,828). This belt is subject to wear. Moreover, because the film is not under tension while the hem seal is being formed, the speed at which the film is moving while the hem seal is being formed can be limiting.

Thus, a draw tape bag, section, machine or system that provides the advantages of the prior art machines, but does not have a hem seal belt that wears is desirable. Also, a draw tape bag system that provides the advantages of the prior art machines, but forms the hem seal while the film is under tension is also desirable.

### SUMMARY OF THE PRESENT INVENTION

According to a first aspect of the disclosure a bag machine includes an infeed section and a draw tape section. Bags are made from a film and a film path extends through the infeed section. The film path also extends from the infeed section through the draw tape section, and the draw tape section is in a downstream direction from the infeed section. The draw tape section includes a hem sealer, and the film path further extends through hem sealer. The hem sealer includes a stationary sealing plate on a one side of the film path such that film path passes across the stationary plate. A sealing head is on a second side of the film path, opposite the first side, such that the film following the film path passes between the sealing head and the stationary plate.

According to a second aspect of the disclosure a method of making bags from a film includes feeding the film through an infeed section along a film path and then through a draw tape section along the film path. Feeding the film through the draw tape section includes feeding the film through a hem sealer by passing the film between a stationary sealing plate and a sealing head, and forming a hem seal on the film as it passes between the stationary sealing plate and the sealing head.

The bag machine includes a sealing section, and the sealing section is downstream from the draw tape section in one alternative.

The draw tape section includes an infeed nip and an outfeed nip, and one or both of the infeed nip and the outfeed nip are driven nips in various embodiments.

The infeed and outfeed nips are driven by servo motors in another embodiment.

The stationary sealing plate extends a first length in the machine direction and the stationary sealing plate has a sealing surface that extends in generally a sealing plate plane in one alternative.

The sealing head extends a first head length in the machine direction and the sealing head has a sealing head surface that extends generally in a sealing head plane which is generally parallel to the sealing plate plane, and the film path passes between and generally parallel to the sealing head plane and the sealing plate plane in another alternative.

The stationary sealing plate extends a second length in the cross direction and the second length is less than the first length in one embodiment.

The sealing head includes a plurality of air holes disposed to direct air to the film path whereby hot air passing through the air holes impacts the film and forms a hem seal on the film in various embodiments.

The air holes are disposed and shaped such that the distance between the sealing head surface and the film path affects a width of the hem seal in one alternative.

The sealing head is comprised of metal in another alternative.

The stationary sealing plate is comprised of metal and/or plastic in one embodiment.

The stationary sealing plate is comprised of at least one of metal coated steel, stainless steel, plastic and composites in various embodiments.

The sealing surface is textured or smooth alternatives.

The sealing surface has air holes disposed therein in another alternative.

Other principal features and advantages of will become apparent to those skilled in the art upon review of the following drawings, the detailed description and the appended claims.

### BRIEF DESCRIPTION OF THE DRAWINGS

FIG. 1 is a draw tape section of a prior art bag machine;

FIG. 2 is a sealing section and infeed section of a prior art bag machine;

FIG. 3 is a draw tape bag machine in accordance with the preferred embodiment;

FIG. 4 is a perspective view of components of a hem sealer in accordance with the preferred embodiment;

FIG. 5 is a side view of components of the hem sealer of FIG. 4;

FIG. 6 is a side view of upper and lower hem drives in the hem sealer of FIG. 4;

FIG. 7 is a perspective view of a drive for the hem sealer of FIG. 4;

FIG. 8 is a perspective view of a servo motor on the drive of FIG. 7;

FIG. 9 is a perspective view of servo motors on the hem sealer of FIG. 4;

FIG. 10 is a perspective view of servo motors on the infeed and outfeed nips of the hem sealer of FIG. 4;

FIG. 11 shows a draw tape section with a stationary sealing plate surface having air holes 1101 to support the hem as it is being sealed;

FIG. 12 shows a draw tape section with a stationary sealing plate surface having air holes 1201 to support the hem as it is being sealed; and

FIG. 13 shows a hem sealer with air holes 1201 to support the hem as it is being sealed.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components, unless otherwise indicated.

### DETAILED DESCRIPTION OF THE PREFERRED EMBODIMENTS

While the present disclosure will be illustrated with reference to a particular bag making system, it should be understood at the outset that the invention can be implemented in other systems.

The preferred embodiment of the invention will be described in the context of prior art bag machines, including a draw tape section such as those shown in U.S. Pat. Nos. 5,857,953 and 5,797,828, an infeed section and a sealing section such as those shown in U.S. Pat. Nos. 6,117,058, 7,445,590, 8,029,428 and 8,998,787, and a winding section such as those shown in U.S. Pat. Nos. 5,377,929 and 7,578,779 (both of which are hereby incorporated by reference).

Generally, the preferred embodiment provides for a draw tape section with a hem sealer that forms the hem seal as the film passes across a stationary plate, preferably, a driven infeed nip and a driven outfeed nip provide tension to the film while the seal is being formed.

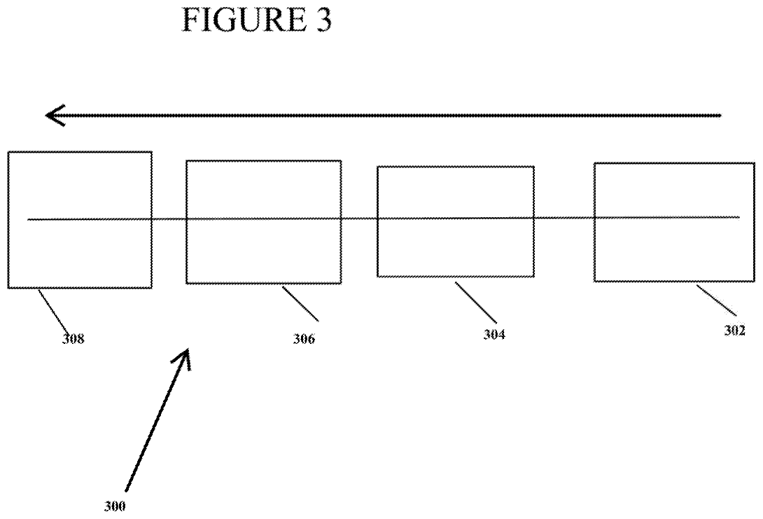

FIG. 3 is a draw tape bag machine 300 in accordance with the preferred embodiment and includes an infeed section 302, a draw tape section 304, a sealing section 306 and a winder 308. The invention can be implemented without any of infeed section 302, sealing section 306 and winder 308, or could be implemented by retrofitting an existing hem sealer in a draw tape section. Infeed section, as used herein, refers to a section that receives film or other material to be made into a bag, and may be simply a nip, or other components such as dancers, etc. Draw tape section, as used herein, includes a section of a bag machine where a hem seal is formed to hold a draw tape. Sealing section, as used herein, is the section of a bag machine where one or more seals are imparted to form or partially form a bag, and a hem sealer can be part of a sealing section, or part of a draw tape section.

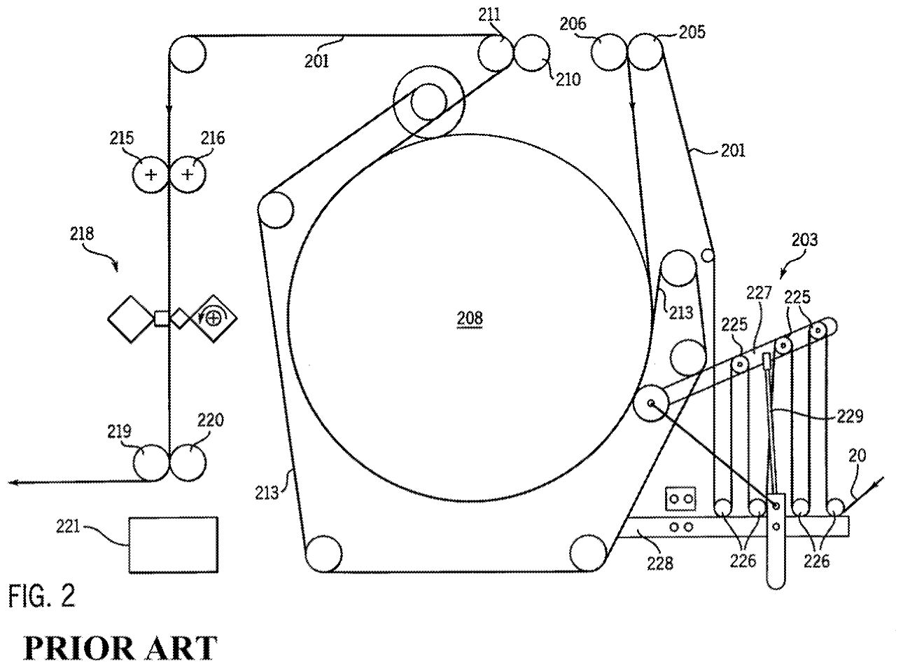

FIG. 2 shows a prior art infeed section (found in U.S. Pat. No. 6,117,058), which is used to implement infeed section 306 in the preferred embodiment. Infeed section 306 includes a dancer assembly 203 includes a plurality of upper rolls 225 and lower rolls 226. Rolls 225 and 226 are mounted on arms 227 and 228, which are pivotally inter-connected. An air cylinder 229 is used to adjust the tension applied to film 201. The vertical distance between rolls 225 and 226 is determined by the tension applied to film 201 (and is related to the speed of film 201). Air cylinder 229 is controlled by controller 221. Alternative embodiments include using a different number of dancer rolls, other arrangements to control the position of the dancer rolls, or other infeed sections.

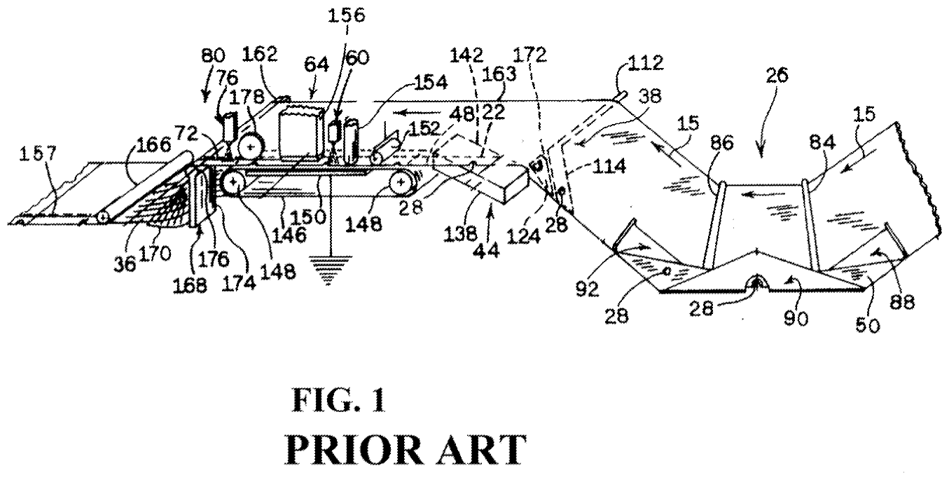

FIG. 1 shows a prior art a draw tape section (found in U.S. Pat. Nos. 5,857,953 and 5,797,828) which is used to implement the draw tape section, but modified to have a hem sealer that forms the hem seal as the film passes across a stationary plate, and to have a driven infeed nip and a driven outfeed nip provide tension to the film while the seal is being formed, as described in detail below.

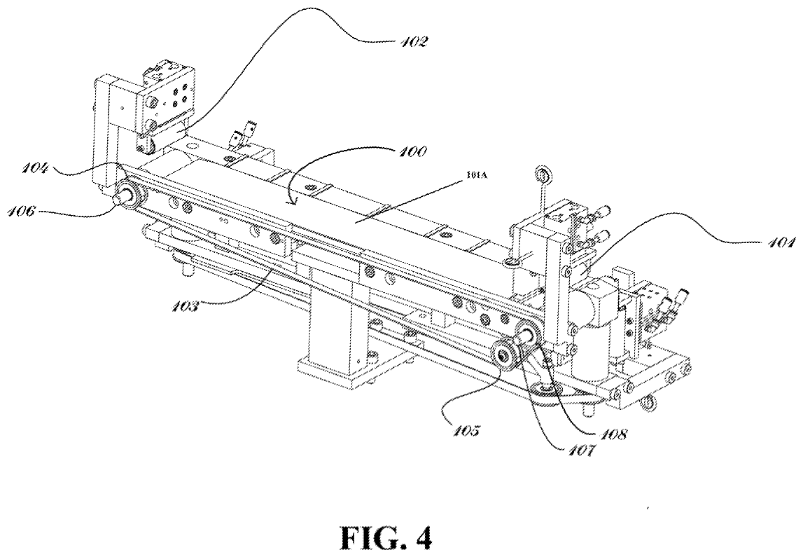

FIG. 4 shows some of the components of a hem sealer in accordance with the preferred embodiment, including a sealing plate 100, an infeed nip 101, an outfeed nip 102, a drive belt 103, an outfeed pulley 104, a belt take idler 105, an outfeed roll 106, an infeed roll 107 and an infeed drive pulley 108. The film passes along a film path from left to right through the hem sealer, and is over stationary sealing surface 101A of stationary sealing plate 100 (rather than belt 146 of the prior art design of FIG. 1). Hem sealer, as used herein, is a sealer that forms a hem seal. Film path, as used herein, is the path a film generally follows as it passes through a bag machine. Stationary sealing plate, as used herein, is a plate which the film passes across as a seal is formed, without having a belt or other moving item between the film and the stationary sealing surface. Sealing surface, as used herein, is the surface of a stationary sealing plate that the film passes across as the film is sealed.

Plate 100 supports the film as the seal is being formed, and replaces prior art belts (such as 146 of FIG. 1) which needed frequent replacement as they wore. Also, infeed 101 and outfeed nip 102 cooperate to control the film tension as the seal is being formed. By keeping the web under tension flutter can be reduced and seals can be more consistently formed. Sealing plate 100 is smooth in the embodiment of FIG. 4, and textured in another embodiment. Textured, as used herein, refers to an intentionally uneven surface. Smooth, as used herein, refers to a surface that is not but for minor imperfections. Sealing plate 100 can be coated, stainless steel, low friction materials such as plastics; composites, etc. Sealing plate 100 can be an air table that provides air to “float” the web across the table to reduce friction. The air can be perpendicular to the film path, or at an angle to the film path.

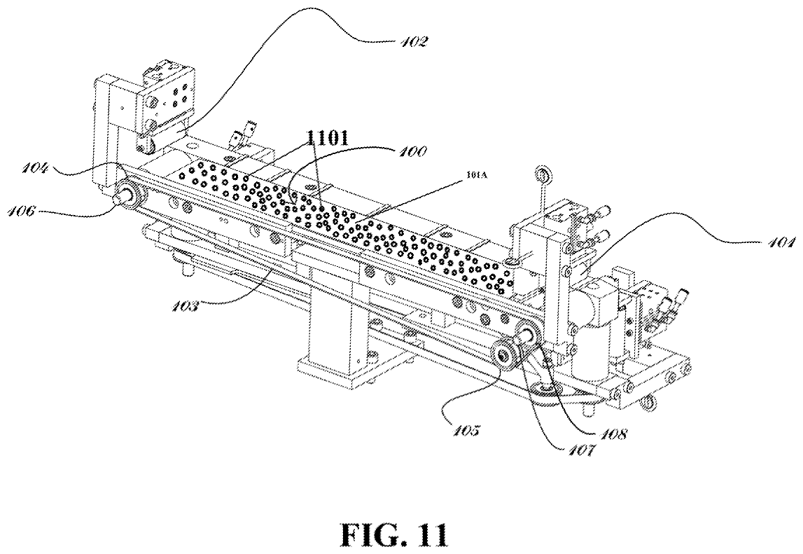

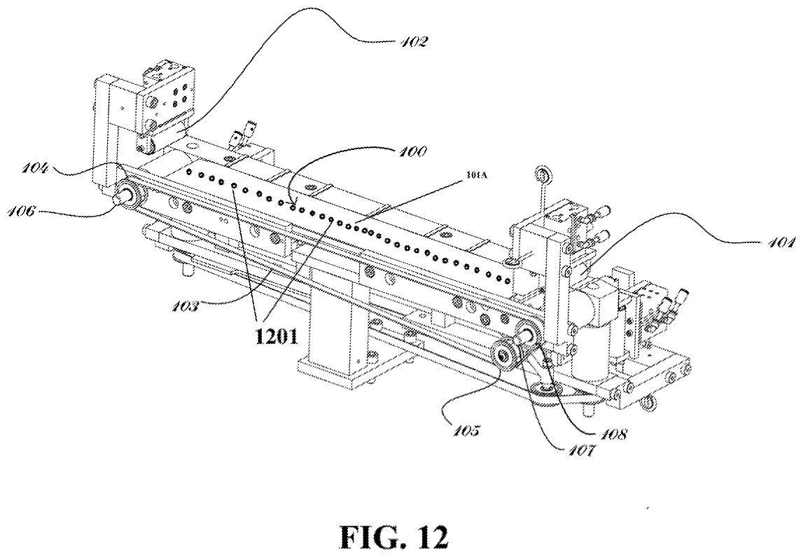

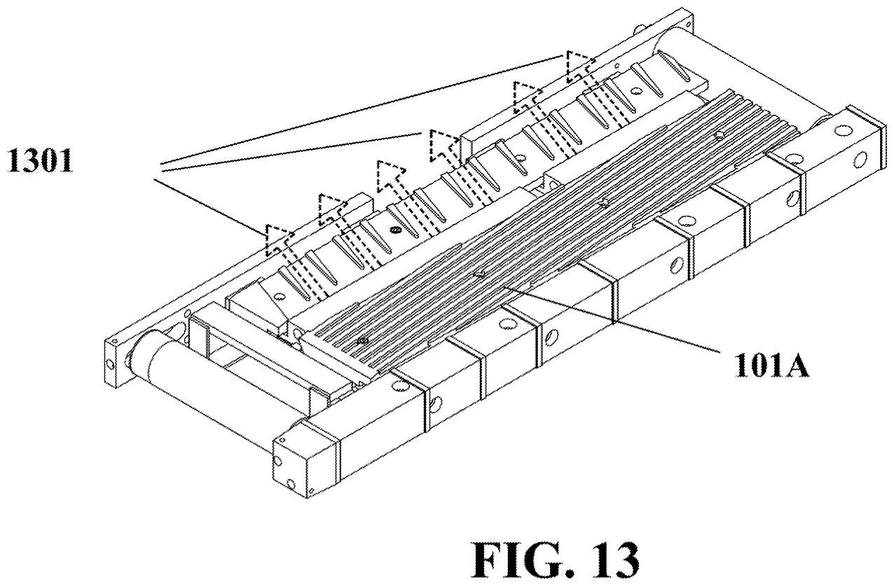

One embodiment of sealing surface 101A, shown in FIG. 11, provides for sealing surface 101A to have air holes 1101 throughout, thus forming an air table to support the film as the hem seal is formed. Another embodiment, shown in FIG. 12, provides for air holes 1201 to be in the middle of the hem, so that air flow from the center of the hem to the edges of the hem, and supports the film as the hem seal is formed. A hem sealer with air flow under the film other than on the hem is shown in FIG. 13. The film travels from the lower left to the upper right. Arrows 1301 depict air flow. Air flow is planar parallel to the film, but angular to the film direction. Air is directed to support the film outside of the hem, and can flow under the hem. Alternatives provide for non planar parallel and angular to the film plane and the film direction (more of an upward direction), or up to perpendicular to the film plane. Surface 101A is textured, with grooves angled to the film direction.

The preferred embodiment provides that a sealing surface 101A of plate 100 lies generally in a plane, and that the film path (and thus the film) also lie generally in a plane that is parallel to the sealing surface plane. Generally in a plane, as used herein, refers to an item that is, but for minor perturbations or imperfections, in a plane. Generally parallel, as used herein, refers to items that are parallel, but for minor perturbations or imperfections.

Infeed nip 101 and outfeed nip 102 may be smooth or textured, and are preferably comprised of coated rollers. The diameters of the infeed and outfeed rollers may be the same, or they may be different, to overspeed one of them (if they are driven together). Alternatives provide for each nip to be independently driven, and the over speed, if desired, if provided by commanding different speeds. Over speeding the outfeed nip provides tension to the film.

Drive belt 103 drives both infeed nip 101 and outfeed nip 102 in the preferred embodiment, and thus any over speed is provided by having the outfeed nip rollers be a different diameter than the infeed nip rollers (or by providing gearing). Drive belt 103 may be similar to drive belts found elsewhere in the bag machine, and can be a toothed timing belt, a smooth belt, a profiled belt, or a variable pitched drive system.

Outfeed drive pulley 104 preferably has the same pitch diameter as infeed drive roll 107, but could have a different pitch diameter as infeed roll for ratio change. Belt take-up idler roll 105 removes slack from belt 103. Outfeed drive roll 106 and infeed drive roll 107 can be smooth, textured, coated, have the same or different diameters, or could be replaced with a self-contained drive inside the nip roll. Infeed drive pulley 108 preferably has the same pitch diameter as infeed drive roll 107, but could have a different pitch diameter as infeed roll for ratio change.

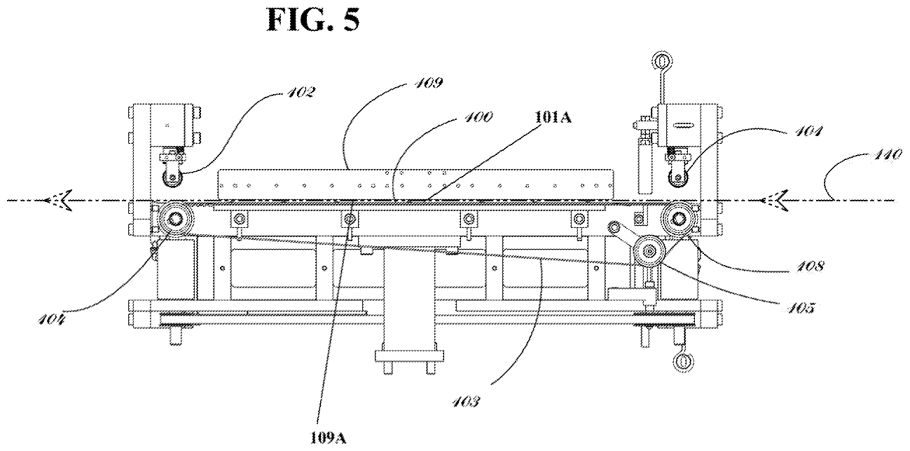

FIG. 5 is a side view of components of the hem sealer of FIG. 4, but includes sealing head 109, and shows film path 110 (and sealing surface 101A is textured in this embodiment). Sealing head 109 can be a sealing head from the prior art, and includes a sealing head surface 109A that is generally in a plane and generally parallel to sealing plate surface and the film path 110. Sealing head, as used herein, is a device which provides the heat and/or pressure to form a seal. Sealing head surface, as used herein, is the surface of a sealing head which provides or directs heat to the film to seal the film.

The preferred embodiment provides for a sealing head with holes that direct hot air to the film to form the hem seal. Because the air generally forms a cone as it moves toward the film, adjusting the distance from sealing head surface 109A to film path 110 (and thus the film) the heat zone (and thus hem seal), adjusts the width of the hem seal. One embodiment provides for a distance of 29.5 inches between infeed nip 101 and outfeed nip 102, and a hem seal having a width of 1/16 to ⅛ inch (adjusted by the distance between sealing head surface 109A and film path 110). The hem can be adjustable and various embodiments provide for hems from ⅜ of an inches to 7 or more inches.

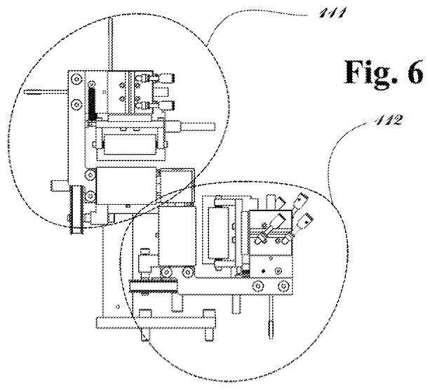

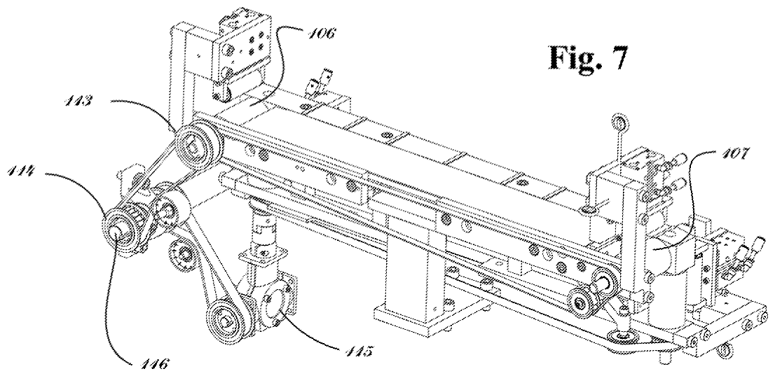

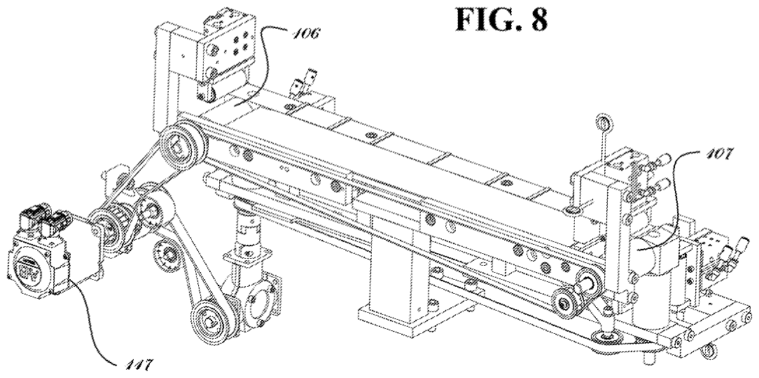

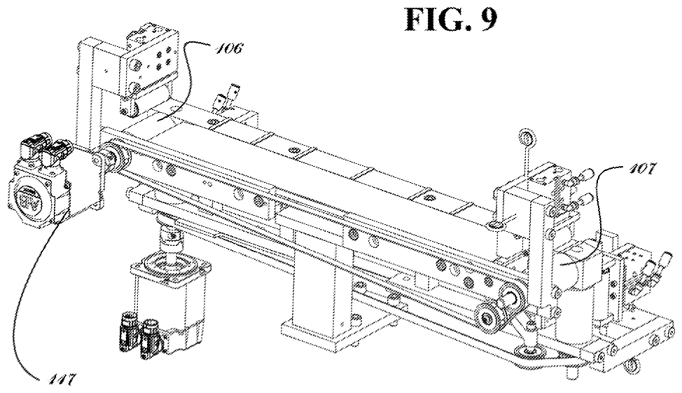

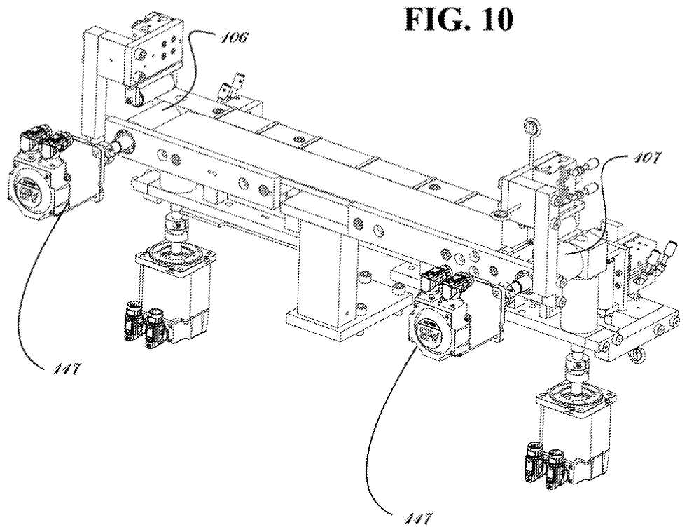

FIG. 6 is a side view of upper and lower hem drives in the hem sealer of FIG. 4, with showing an upper hem drive 111 and a lower hem drive 112. FIG. 7 is a perspective view of a drive for the hem sealer of FIG. 4, including a jack shaft upper outfeed driven pulley 113, a jack shaft upper outfeed drive pulley 114, a jack shaft lower outfeed drive system 115 and a jack shaft input drive shaft 116. FIG. 8 is another perspective view, but adds servo drive 117. FIG. 9 is another embodiment of hem sealer of FIG. 4, but uses direct drive upper and lower servo motors 117. FIG. 10 is another perspective view of a hem sealer and shows servo motors 117 on infeed nip 101 and outfeed nip 102.

Numerous modifications may be made to the present disclosure which still fall within the intended scope hereof. Thus, it should be apparent that there has been provided a method and apparatus for making bags with hem seals that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

The embodiments of the invention in which an exclusive property or privilege is claimed are defined as follows:

1. A bag machine for making bags from a film, comprising:
an infeed section, wherein a film path extends through the infeed section;
a draw tape section, wherein the film path further extends from the infeed section through the draw tape section such that a downstream direction is from the input section to the draw tape section, and wherein the draw tape section includes a hem sealer, and the film path further extends through the hem sealer, wherein the hem sealer includes a stationary sealing plate disposed on a first side of the film path such that film path passes across the stationary sealing plate, and wherein the hem sealer includes a sealing head disposed on a second side of the film path, opposite the first side, such that the film following the film path passes between the sealing head and the stationary plate.

2. The bag machine of claim 1, further comprising a sealing section, wherein the film path extends through the sealing section, such that the downstream direction is from the draw tape section to the sealing section.

3. The bag machine of claim 1 wherein the draw tape section includes an infeed nip and includes an outfeed nip, wherein at least one of the infeed nip and the outfeed nip is a driven nip.

4. The bag machine of claim 3 wherein the infeed nip is a driven infeed nip and the outfeed nip is a driven outfeed nip.

5. The bag machine of claim 3 wherein an infeed servo motor drives the driven infeed nip and an outfeed servo motor drives the driven outfeed nip.

6. The bag machine of claim 1 wherein the stationary sealing plate extends a first length in the machine direction and wherein the stationary sealing plate has a sealing surface that extends in generally a sealing plate plane.

7. The bag machine of claim 6 wherein the sealing head extends a first head length in the machine direction and wherein the sealing head has a sealing head surface that extends generally in a sealing head plane, wherein the sealing head plane is generally parallel to the sealing plate plane, and wherein the film path passes between and generally parallel to the sealing head plane and the sealing plate plane.

8. The bag machine of claim 7 wherein the stationary sealing plate extends a second length in the cross direction and the second length is less than the first length.

9. The bag machine of claim 8 wherein the sealing head includes a plurality of air holes disposed to direct air to the film path, whereby hot air passing through the air holes impacts the film and forms a hem seal on the film.

10. The bag machine of claim 9 wherein the plurality of air holes are disposed and shaped such that the distance between the sealing head surface and the film path determines, whereby hot air passing through the air holes to the film affects a width of the hem seal.

11. The bag machine of claim 10 wherein the sealing head is comprised of metal.

12. The bag machine of claim 11 wherein the stationary sealing plate is comprised of at least one of metal and plastic.

13. The bag machine of claim 11 wherein the stationary sealing plate is comprised of at least one of metal coated steel, stainless steel, plastic and composites.

14. The bag machine of claim 11 wherein the sealing surface is one of textured and smooth.

15. The bag machine of claim 11 wherein the sealing surface has air holes disposed therein.

16. A method of making bags from a film includes comprising:
feeding the film through an infeed section along a film path;
feeding the film through a draw tape section along the film path after the film passes through the infeed section, including feeding the film through a hem sealer, wherein feeding the film through a hem sealer includes passing the film between a stationary sealing plate and a sealing head, and forming a hem seal on the film as it passes between the stationary sealing plate and the sealing head.

17. The method claim 16, further feeding the film through a sealing section after the film passes through the draw tape section.

18. The method of claim 17, further comprising feeding the film through an infeed nip before passing the film between the stationary sealing plate and the sealing head and feeding the film through an outfeed nip after passing the film between the stationary sealing plate and the sealing head, wherein the speed of the infeed nip and the outfeed nip controls the tension of the film as it passes between the stationary sealing plate and the sealing head.

19. The method of claim 18, further comprising driving the infeed nip and driving the outfeed nip.

20. The method of claim 19 wherein passing the film between the stationary sealing plate and the sealing head includes passing the film generally in a plane.

21. The method of claim 20 wherein forming a hem seal includes directing hot air through a plurality of air holes in the sealing head and to the film.

22. The method of claim 21 further comprising adjusting the width of the hem seal by adjusting a distance between the sealing head and the film path.

23. The method of claim 22 further comprising directing air through the stationary sealing plate.
